(19) United States
(12) Patent Application Publication
(10) Pub. No.: US 2002/0022980 A1
(43) Pub. Date: Feb. 21, 2002

(54) Method and system for coordinating real estate appointments

(76) Inventors: Bahram Mozayeny, Edina, MN (US); John Mosey, Edina, MN (US)

Correspondence Address: James H. Ackley, Dorsey & Whitney LLP, 220 South Sixth Street, Minneapolis, MN, 55402-1498, US

(21) Appl. No.: 09/957,178

(22) Filed: Sep. 20, 2001

Related U.S. Application Data
(63) Continuation-in-part of application No. 09/477,573, filed on Jan. 4, 2000.

(51) Int. Cl. G06F 17/60

(52) U.S. Cl. 705/5

(57) ABSTRACT

A method for scheduling real estate appointments. The method comprises receiving from a showing realtor a request to show property, and automatically communicating the request to show property to a seller of the property, the act of communicating including soliciting appointment approval from the seller.

### RELATED APPLICATION

This application is a continuation-in-part of U.S. Patent Application Ser. No. 09/477,573. filed Jan. 4, 2000, entitled “A Method and System for Coordinating Real Estate Appointments,” by Bahram Mozayeny and James E. Asbury, which is hereby incorporated by reference in its entirety.

### TECHNICAL FIELD

This invention relates to computerized methods and systems for the real estate business. More particularly, this invention relates to computerized methods and systems for communicating and setting up listings and showings for real estate and for monitoring real estate activity. The methods and systems are implemented in computer hardware and software.

### BACKGROUND

Real estate transactions typically involve the use of real estate agents to set up and coordinate real estate showings and sales. The seller of a property uses a listing agent to act as an agent to organize and facilitate the sale of the property. Potential buyers also use agents to set up showings and to facilitate the purchase of a property. Throughout this specification, an agent for a potential buyer who shows property to the buyer will be referred to as a “showing agent” or a “showing realtor.” Such a showing agent typically works for a real estate broker, which will be referred to as a “showing office.” Similarly, a “listing agent” or “listing realtor,” who typically works for a real estate broker referred to as a “listing office,” is an agent for the seller of the property. The term “seller” will be used in the specification to refer to the actual seller or occupant of the property and, more broadly, to the listing agent (or listing realtor) who acts as an agent for the seller. Similarly, the term “buyer” will be used in the specification to refer to the actual potential buyer of the property and, more broadly, to the showing agent (or showing realtor) who acts as an agent for the potential buyer.

FIG. 1 illustrates the typical appointment process used in the prior art to set up an appointment for a showing agent to show a property to a potential buyer. A seller 10 uses a listing agent 12 to submit a listing 30 to the listing office 14 of the listing agent 12 and to the multiple listing service (“MLS”) 16. The MLS 16 is a database of listed properties commonly used by listing agents 12 to list properties and used by showing agents 18 to find property that may be suitable for a potential buyer. After a showing agent 18 finds a suitable property listing from the MLS 16, the showing agent requests 32 from the listing office 14 an appointment time by telephone to view and show the property. Such a request 32 may be for a specific time or may be an open-ended request for a suitable time from the seller 10. An agent or staff member at the listing office 14 then communicates 34 with the seller 10, typically over the telephone, to determine if the requested showing time is acceptable to the seller 10. The seller's message is then communicated 36 from the listing office 14 to the showing office 20, and the listing office 14 will also let the listing agent 12 know of scheduled showings (numeral 38).

After a property is shown to a potential buyer, the showing agent 18 is typically required to give feedback 40 to the listing agent 12 about the property. Such feedback 40 typically occurs over the phone. The listing agent 12 may also communicate 42 with the seller 10, sharing information about the property and deciding what further steps may be taken to facilitate the sale of the property.

The method and system described above to schedule appointments for real estate transactions has a number of disadvantages. First, the method requires a great deal of human interaction on behalf of both the listing office 14 and the showing agent 18 or showing office 20, which increase costs and requires real estate agents to spend a significant amount of time scheduling appointments. The MLS 16 contains listings of property and aids the showing agent 18 in finding properties to show, but it does not automate the scheduling process for showing property. The showing agent 18 must therefore request 32 a showing time over the phone, and the listing office 14 must communicate 34 this request to the seller 10. Such a process requires a great deal of human interaction on behalf of both the listing office 14 and the showing agent 18 or showing office 20. The connections shown in broken line in FIG. 1 indicate the need for human interaction in the appointment scheduling process. Reducing the amount of human interaction would decrease costs and would save real estate agents a significant amount of time in scheduling appointments.

A second problem with the process of FIG. 1 is that the feedback 40 process between the showing agent 18 and the listing agent 12 makes it difficult to collect useful information. Feedback 40 is typically required by the showing agent 18. The showing agent 18, however, does not receive a tangible benefit from giving feedback 40 to the listing agent 12, and the feedback 40 is therefore frequently not meaningful or timely.

A third problem with the process of FIG. 1 is that it does not automatically mine and make available information about requests for information for a property, the number of showings for a property, the number of information requests that do not result in showings, the number of showings for which no further inquiries were made by the showing agent 18, or other market information relevant to buyers and sellers of real estate. Such information may prove useful to a listing agent 12 if gathered and presented in a usable form.

A method and system is needed to automate the appointment process for real estate transactions. Such a method and system is also needed to facilitate and automate the feedback process between showing agents and listing agents and to mine useful information for use by listing agents. In addition, a method and system that enables collecting and making available to buyers and sellers of real estate market information relevant in a usable form is desirable.

### SUMMARY

In one embodiment, the invention is a method for scheduling real estate appointments. In this embodiment, the method comprises receiving from a showing realtor a request to show property, and automatically communicating the request to show property to a seller of the property, the act of communicating including soliciting appointment approval from the seller. In this embodiment, the method may also comprise automatically requesting feedback from the showing realtor and communicating feedback results to a listing realtor after a property showing has occurred.

Another embodiment of the invention is an apparatus for scheduling real estate appointments. In this embodiment, the apparatus comprises an appointment server containing instructions for receiving from a showing realtor a request to show property and instructions for automatically communicating the request to show property to a seller of the property, the act of communicating including soliciting appointment approval from the seller.

In another embodiment of an apparatus for scheduling real estate appointments, the invention comprises a server for receiving a request from a buyer for showing a property and a communication system operably connected to the server for automatically communicating the request to a seller of the property and for communicating an answer to the buyer.

Another embodiment of the invention is a method for scheduling real estate appointments. In this embodiment, the method comprises compiling in an appointment server showing information for a listed property, receiving in the appointment server from a showing realtor a request to show the property, determining from the showing information if the request to show the property is acceptable to a seller of the property, electronically communicating the request to show property to the seller of the property if the showing information is not sufficient to determine if the request to show the property is acceptable to the seller, the act of communicating including soliciting appointment approval from the seller, electronically receiving a response from the seller regarding appointment approval, and electronically communicating to the showing realtor the response from the seller.

Yet another embodiment of the invention is an apparatus for scheduling real estate appointments. In this embodiment, the apparatus comprises means for receiving from a showing realtor a request to show property, and means for automatically communicating the request to show property to a seller of the property, the means for automatically communicating including means for soliciting appointment approval from the seller.

Another embodiment of the invention is a method for gathering feedback from a property showing. In this embodiment, the invention comprises determining that a property showing has occurred and automatically requesting feedback from a showing realtor.

Yet another embodiment of the invention is an apparatus for gathering feedback from a property showing. The apparatus of this embodiment comprises an appointment server containing instructions for determining that a property showing has occurred and automatically requesting feedback from a showing realtor.

Another embodiment of the invention is an apparatus for gathering feedback from a property showing. In this embodiment, the apparatus comprises means for determining that a property showing has occurred and means for automatically requesting feedback from a showing realtor.

Yet another embodiment of the invention is a method for displaying a map. This embodiment of the invention comprises accepting search instructions for listed properties from a showing realtor, searching an appointment database for listed properties fitting the search instructions, communicating property listings to the showing realtor and allowing the showing realtor to select property listings for showing, and generating a map of the selected property listings, wherein the map contains at least two property listings.

Another embodiment of the invention is an apparatus for displaying a map. In this embodiment, the apparatus comprises an appointment server containing instructions for (i) accepting search instructions for listed properties from a showing realtor, (ii) searching an appointment database for listed properties fitting the search instructions, (iii) communicating property listings to the showing realtor and allowing the showing realtor to select property listings for showing, and (iv) generating a map of the selected property listings, wherein the map contains at least two property listings.

In another embodiment of an apparatus for displaying a map, the invention comprises means for accepting search instructions for listed properties from a showing realtor, means for searching an appointment database for listed properties fitting the search instructions, means for communicating property listings to the showing realtor and allowing the showing realtor to select property listings for showing, and means for generating a map of the selected property listings, wherein the map contains at least two property listings.

Another embodiment of the invention is a method for gathering information related to real estate transactions. In this embodiment, the invention comprises automatically requesting feedback from a showing realtor after a property showing for a property listing, gathering feedback results from the showing realtor, and generating reports for the property listing using the feedback results.

Another embodiment of the invention is a method for displaying information related to real estate transactions. In this embodiment, the invention comprises accessing one or more databases to gather market relevant information concerning real estate transactions, and presenting the market relevant information in a meaningful form.

Yet another embodiment of the invention is an apparatus for displaying information related to real estate transactions. In this embodiment, the invention comprises an appointment server containing instructions for (i) accessing one or more databases to gather market relevant information concerning real estate transactions, and (ii) presenting the market relevant information in a meaningful form.

Another embodiment of an apparatus for displaying information related to real estate transactions comprises means for accessing one or more databases to gather market relevant information concerning real estate transactions, and means for presenting the market relevant information in a meaningful form.

The above embodiments of the invention provide numerous benefits to buyers and sellers of real estate as well as the agents/entities involved in such transactions. Showings for property may be quickly and efficiently set up using the automated communication features of the invention. In addition, the automated features may benefit the seller of the property by providing for quicker sales and for making appointment scheduling less cumbersome. Other advantages of the invention are discussed throughout the remainder of this specification.

These and other features and objectives of the present invention will become apparent with reference to the drawings, the description of the preferred embodiment, and the appended claims.

### DESCRIPTION OF THE DRAWINGS

FIG. 1 is a block diagram overview of a prior art method and system for making appointments for real estate showings.

FIG. 2 is a basic block diagram overview of the system of one embodiment of the invention.

FIG. 3 is a block diagram overview of one embodiment of the system of the invention that illustrates the flow of communications in the invention.

FIG. 4 is a block diagram overview of an embodiment of the system of the invention.

FIG. 5 is a web page or database entry for registration of realtors with the system and method of one embodiment of the invention.

FIG. 6 is a web page or database entry for new property listings with the system and method of one embodiment of the invention.

FIG. 7 is a flow chart showing the scheduling and appointment process of one embodiment of the invention.

FIG. 8 is a web page or database entry for a feedback request for use in one embodiment of the invention.

FIG. 9 is a web page or database display for a control panel with the system and method of one embodiment of the invention.

FIG. 10 is a web page or database display for detailed request information with the system and method of one embodiment of the invention.

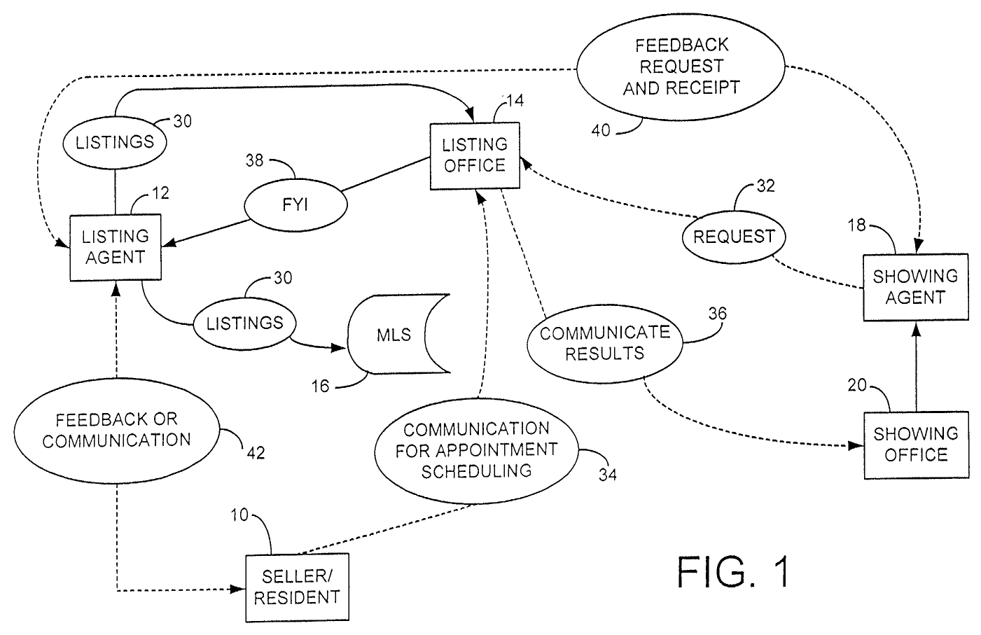

### DETAILED DESCRIPTION

a. General Overview and Equipment of an Embodiment of the Invention

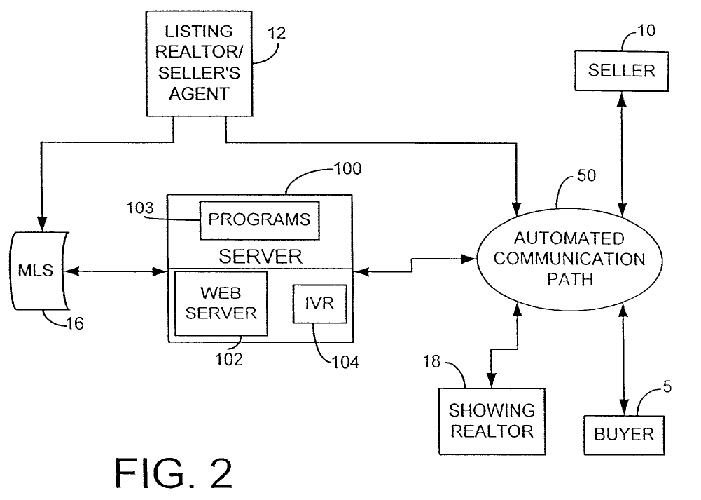

FIG. 2 shows one embodiment of the environment of the invention. In this embodiment, an appointment server 100 communicates with one or more listing realtors 12, showing realtors 18, and sellers 10 over communication path 50. The communication path 50 used within the scope of the invention may be a Local Area Network (“LAN”) of any type, a Wide Area Network (“WAN”), a private network, a public network including the Internet and the Web, or a public telephone network using an interactive voice response system (“IVR”). Communications may be accomplished using standard devices or wireless devices such as cellular phones, palm pilots, satellite dishes, cable, or other electronic communication devices or mediums known to those skilled in the art. The MLS 16 may also be used within the scope of the invention, although the MLS 16 may also be replaced entirely in one embodiment of the invention by the appointment server 100, which may contain real estate listings. In an embodiment using the MLS 16, the appointment server 100 may communicate with the MLS 16 to gather information about listings, and listings added through the appointment server 100 may also be communicated to the MLS 16 so that those listings are listed in the MLS 16. In some embodiments, the MLS 16 may be used for reference from the appointment server 100, such as by providing an Internet link to the MLS 16 from a web page in the appointment server 100. In another embodiment using the MLS 16, addresses and pictures of property, as well as other information, may be uploaded from the MLS 16 to the appointment server 100. The MLS 16, therefore, may be either integral with the appointment server 100 or a completely separate system that is used only for reference from the appointment server 100.

In the embodiment shown in FIG. 2, the appointment process for real estate transactions is automated. The appointment server 100 may include, either separately or as part of the same computer system, a web server 102 that operates a web site that allows for communication with listing realtors 12, showing realtors 18, and possibly also with sellers 10 and buyers 5. The web server 102 may manage all or a portion of the e-mail and Internet communications for the appointment server 100. The appointment server 100 may be any standard computer known to those skilled in the art and may contain a processor, input and output devices, and other conventional features for computer servers. Although the appointment server 100 will be referred to throughout this specification as a single computer, it may be any number of computers networked together into a computer system or it may be one or more computer servers operating over the Web. In addition, the appointment server 100 may, in one embodiment, include an IVR system 104 that also allows for communication to the appointment server 100 through telephone rather than the Web.

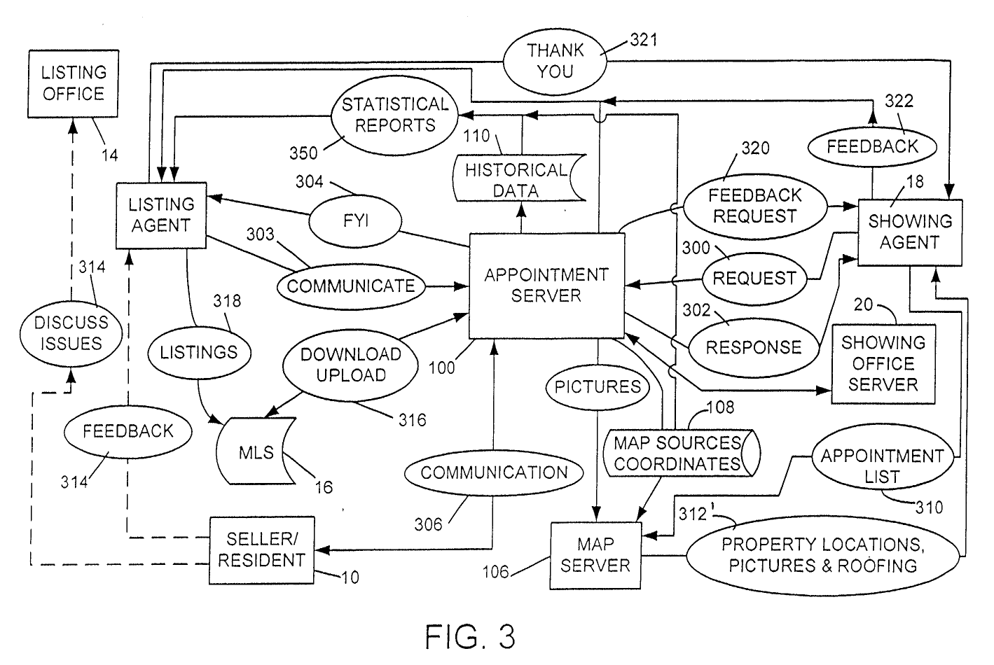

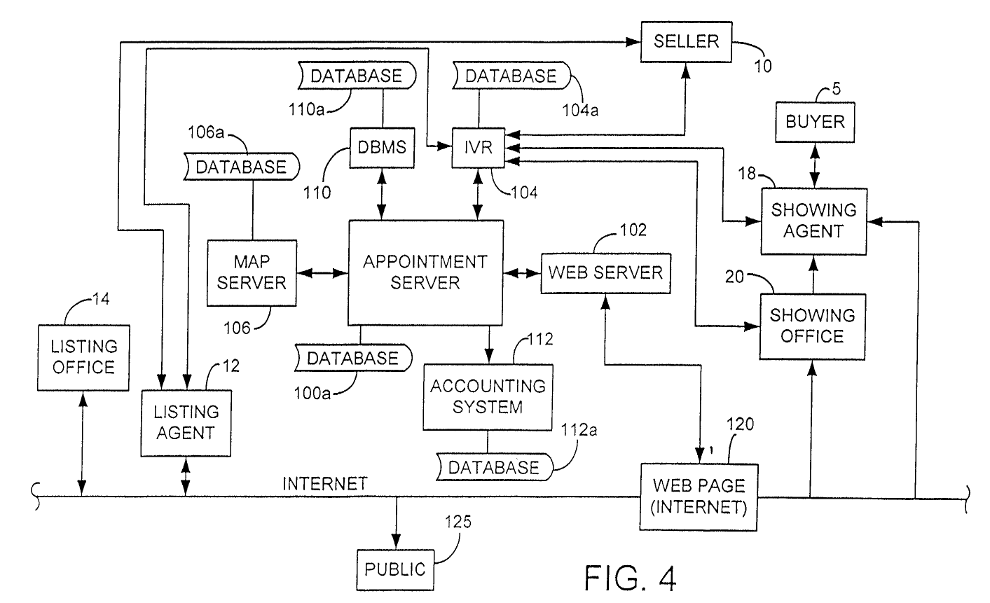

FIGS. 3 and 4 illustrate more detailed embodiments of the appointment server 100 of the invention. FIGS. 3 and 4 illustrate that the appointment server 100 may contain a number of databases or servers, which may be either separate computers or computer systems from the appointment server 100 or applications or databases running on the appointment server 100. A database management server 110 and database 110a that stores listing information for listed properties, historical data, and other programs or information may be part of the appointment server 100. The IVR system 104 may have a server and database 104a to provide for the operation and data storage of the voice response system of the invention. A map server 106 and database 106a may be used in one embodiment to access maps, geographic information, and directions to or from listed properties. An accounting server 112 and database 112a may be used to track listings, transactions, and service charges that may be incurred using the appointment server 100. The accounting server 112 and database 112a may also be used for the automated generation of bills that may be sent via e-mail, a Web application, or standard mail to a realtor. It is to be understood that the databases and servers described above may be used together or separately, may exist within the appointment server 100 or separately or at a remote site. As such, these databases and servers are separately listed only to illustrate that a number of components to the appointment server 100 may exist. In addition, the system and method of the invention may coordinate in uploading and/or downloading information from the MLS 16, as shown in FIGS. 2 and 3 (numeral 316 of FIG. 3).

Any computer systems and software programs known to those skilled in the art may be used within the scope of the invention. In one embodiment, a SUN computer with the Solaris operating system may be used for the appointment server 100, a Compaq computer with the LINUX operating system may be used for the web server 102, and a Compaq computer with WindowsNT, Windows 95 or Windows 98 may be used for the map server 106 and IVR system 104. An ORACLE database management system may be used for the database management server 110, Dialogic communication hardware and software may be used for the telephony and voice communication applications, and Nuance software may be used for intelligent voice recognition. For the mapping features described below, TileGen and IPS software from VectorVision Corp. may be used for map selection and for property registration on maps, and Map Objects software from Environmental Sciences Research Institute may be used for map creation and for the Geographic Information System 108 to overlay different layers of information on a map. It is to be understood that other computer systems and software known to those skilled in the art may also be used. In addition, software or programs 103 within the servers or databases of the appointment server 100 or elsewhere may be used to carry out the functions and operations described above and below.

The web server 102 or IVR system 104 may be set up so that only realtors 12, 18 have access thereto, via either password protection or secured communications paths, although full or partial access may be given to buyers 5 and/or sellers 10 in other embodiments. The references to listing realtor 12, seller 10, and showing realtor 18 in the Figures may refer to the person himself or herself and/or to the computer, computer system or telephone system used by that person for communication through the communication path 50. The web page 120 operated by the web server 102 may have portions that are available generally to the public 125, such as open house showings and maps to those showings, as well as portions that may be accessed only by agents with accounts. The web site may also have information such as online purchasing agreements and the like for purchase or use, brochures or riders for advertising purposes, and links to other web sites that contain valuable information.

In one embodiment, a showing realtor 18 may communicate with the appointment server 100 and request an appointment to show a property using either IVR, as is well know in the art, or using the Web. In the common situation in which the seller 10 of the property will not allow the property to be shown at any time, the appointment server 100 may automatically communicate with the seller 10, typically through the phone but possibly through e-mail or the Web, to request authorization to show the property. After the appointment server 100 has received a response from the seller 10, the response may be automatically communicated to the showing realtor 18, the listing realtor 12, and the listing office 14. In addition, records of requests for showings, showings that are actually set up, and records for other information may be saved in the appointment server 100 so that the records may be used for statistical or business purposes. The feedback process may also be automated by having the appointment server 100 automatically send an e-mail or other request to the showing realtor 18 requesting general or specific information about the showing. These and other features of the invention will be discussed further in the following section.

b. Operation

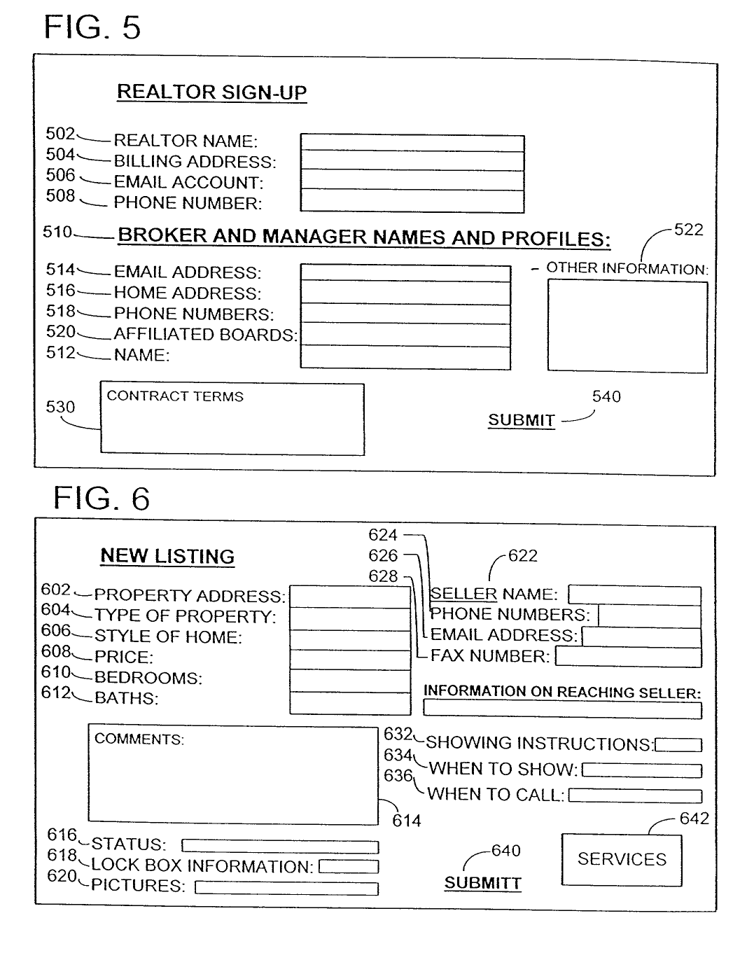

FIGS. 2-4 are block diagrams illustrating embodiments of the system and operation of the invention. FIGS. 5-6 and 8 illustrate potential web pages or database entries that may be used in the operation of the invention. The data listed in FIGS. 5-6 and 8 may be stored in the appointment server 100 of the invention or in the various servers and databases depicted in FIGS. 3 and 4. Although numerous data types are listed in each of FIGS. 5-6 and 8, the invention may function with any subset of the data in the given Figures, such that each type of data is not required for the invention to function.

1. Compiling Broker Information in the Appointment Server

Real estate agent offices, which include both listing offices 14 and showing offices 18, may enroll with a system proprietor of the appointment server 100 by providing certain information. FIG. 5 depicts one embodiment of the information that may be requested from real estate agent offices to sign up with the appointment server 100. The information may be provided via web pages 120, as depicted in FIG. 4, that are run through the web server 102 of the appointment server 100. The information may also be collected in a variety of other methods, such as by using an IVR system 104, through e-mail, traditional mail, or through in-person or telephone conversations. A web page such as that shown in simplified form in FIG. 5, may be used to gather the information, and any variety of data entry methods or systems, including drop down boxes, tab folders, and on and off buttons, used by those skilled in the art may be used to gather the information.

Information for realtors may include the realtor name 502, billing address 504, an email address 506, and a phone number 508, and any other general information about the real estate office. A member identification number (“MIN”) may also be used along with a password for each realtor and/or agent for security purposes. Specific information 510 for each broker, agent, or manager of the real estate office may be collected. Such information may include the realtor's name 512, e-mail address 514, home address 516, phone numbers 518 (which may include home, work, cell, and pagers), and affiliated boards 520, such as the National Association of Realtors and/or state and local real estate boards. Other information 522, including but not limited to web address and billing address and MINs, may also be collected for each agent. Contract terms 530 for the realtor's enrollment with the appointment server 100 may be printed on an enrollment web page or on forms. Such contract terms 530 may include waivers for errors in setting up showing appointments, fee agreements, and other contract terms for the engagement. In a web embodiment, a submit 540 or other button may be present to allow for the submission of the information to the appointment server 100. In one embodiment, the realtor may also submit information regarding the types of property the realtor is looking for, and the appointment server 100 may automatically notify the realtor (by e-mail, the Internet, or otherwise) when a listing meeting the realtor's requirements is entered into the appointment server 100.

Real estate offices may also log on to the appointment server 100 and check billing information for accounts, generate reports on property listings, modify listings for property, and perform other managerial functions for their accounts.

2. Compiling Listing Information in the Appointment Server

A listing agent 12 or listing office 14 may submit a new listing or update an existing listing through the appointment server 100. In an embodiment using the MLS 16, listings submitted through the MLS 16 may be updated to the appointment server 100 on regular intervals so that the appointment server 100 has current information about the listing. Similarly, listings may be downloaded from the appointment server 100 to the MLS 16. FIG. 3 indicates the uploading or downloading of information between the MLS 16 and the appointment server 100 as numeral 316, and the submission of listings by the listing agent 12 to the MLS 16 as numeral 318. In addition, listings added directly by listing agents 12 to the appointment server 100 may be downloaded to the MLS 16 so that the MLS 16 has current information about those listings. In the event that listing information is uploaded from the MLS 16 to the appointment server 100 instead of added directly to the appointment server 100, the listing agent 12 may need to supply additional information, such as seller-specific information, to the appointment server 100 so that the method and system of the invention may operate. In such an embodiment, the appointment server 100 may send an email to the listing agent 12 or seller 10 to request the information, or, in another embodiment, place an IVR phone call to request the information. It should also be understood that in one embodiment of the invention the MLS 16 may not be used, such that only those listings added directly to the appointment server 100 will be used in operation of the invention.

FIG. 6 illustrates some of the information that may be used for a new real estate listing. As for the information shown in FIG. 5, this information may be requested in a web page or through other methods, and the discussion with respect to the information of FIG. 5 applies to the new listing information of FIG. 6 as well.

Basic information about a property for a new listing, such as the property address 602, the type of property 604, the style of home or property 606, the price 608, the number of bedrooms 610, and the number of baths 612, may be entered. In addition, the Property Identification Number (“PID”) for the property may be entered, which is generally assigned by the county of the property and identifies the property for several purposes, such as tax purposes. A description of any of these features may also be provided in one embodiment, and other comments 614 about the home may also be provided. Information about the seller 10 may also be entered, such as the seller's name 622, phone numbers 624, and facsimile numbers 628. Other information 630 about reaching the seller 10, such as the best time 636 to call the seller 10 or the location of the seller 10 at different times of the day, may also be entered. Specific or general showing instructions 632 and times to show the property 634 may also be entered. Lock box information 618, which may, in one embodiment, be kept in a database separate from address information or seller information for security purposes, may be entered into the appointment server 100. Status information 616, such as whether a listing is a new listing or otherwise, may also be entered. The appointment server 100 may automatically update status information if the listing remains on the system (updating the status from “new” to “on market” after a set period of time, such as 10 days, or listing a property as being sold). Pictures 620, drawings, or other artistic representations of property may also be submitted. Finally, information about real estate related services 642, such as loan information, may also be included for advertising purposes.

For each listing added to the appointment server 100, a map may be associated with the listing to aid potential buyers 5 and showing agents 18 in finding the property. The map may be a simple, low detailed map, or a higher detailed map of the area. The map may be generated automatically by the appointment server by using well-known on-line map sources, such as Mapquest, or by asking listing agents 12 to supply a map for inclusion in the listing record. In addition to a map showing the location of the property, directions from well-known cities, landmarks, locations, highways, or roads may be included to aid in showing the property. In one embodiment, the maps may be large enough and detailed enough for use in a vehicle when driving to or between listings. The directions may also be provided by online sources or by the listing agent 12 himself or herself when listing the property.

In one embodiment, a listing added by a listing agent 12 is not immediately available to all showing agents 18. Instead, the availability of the listing to all showing agents 18 is delayed by a distribution delay factor so that only listing agents 12 from the listing office 14 of the listing agent 12 who added the listing will have immediate access to the listing. This allows agents from the listing office 14 of the listing agent 12 who added the listing to have the first opportunity to sell the property. The distribution delay factor can be any amount of time, such as from one hour to two weeks. After the period of the distribution delay factor is up, the listing will be generally available to all listing agents 12.

3. Setting Up Appointments to Show Property

a. Searching for Property

After real estate brokers have registered with the appointment server 100, the server may be used to find property with specific characteristics and to arrange for a showing of the property. The appointment server 100 may contain a web page that allows for searching for property by showing agents 18 or, in another embodiment, by potential buyers 5. The web page may be any type of web page known to those skilled in the art and may use any known searching software or technique. A showing agent 18 may be required to log on to the web site, which may require password control, prior to searching for property. Searches may be conducted by any data type contained in the listing information, such as searches by area code, city, property type or style, price range, number of bedrooms, or number of baths. In one embodiment, searches conducted through the appointment server 100 may search through the MLS 16 for property and display partial or entire records for any listings in the MLS 16 that are not included in the appointment server's 100 records. Through the use of a single appointment server 100, or through a networked group of appointment servers 100, showing agents 18 from many real estate offices can arrange for showings of property.

After a search has been conducted, the showing agent 12 may view records for the property listing retrieved in the search. The records may contain all or a portion of the information depicted in FIG. 6, and the record may be displayed with pictures of the property, a map of the location, and directions to the location from nearby highways, roads, cities, or landmarks.

The showing agent 18 may next request those listings that he or she desires to show to a potential buyer 5. After the showing agent 18 selects those listings, the appointment server 100 (and more specifically the map server 106) may generate a map showing the location of each listing (with a number, letter, or otherwise). The map may also contain directions for the showing agent 18 so that the showing agent's 18 route from property listing to property listing is defined. In another embodiment, a map with each retrieved listing may be displayed to the showing agent 18, and the showing agent 18 may be allowed to select a desired order to show the listings. FIG. 3 indicates requests for map information for appointment lists as numeral 310 and a response with map information from the appointment server 100 as numeral 312. After the showing agent 18 has reshuffled the listings into a desired order for showing, a map may be depicted that shows the locations of the listings, a route to show the listings, and directions to get from one listed property to the next. The map and directions may be printable so that the showing agent 18 can use the map and directions for showings. In an embodiment where only showing agents 18 and not potential buyers 5 have access to the appointment server 100, the maps and directions may be e-mailed or copied and electronically forwarded to potential buyers 5 so that the potential buyers 5 can see the locations of property and drive between properties themselves. A potential buyer 5 may also wish to view the properties himself or herself prior to scheduling a showing, and the potential buyer 5 may therefore eliminate certain properties prior to scheduling an actual showing.

Certain information about property listings may be contained on a report that is for a showing agent's eyes only. Such information includes lock box combinations, showing instructions, and other pertinent information.

A variety of other information may be presented to a showing agent 18 when results from a search are presented. Such information may include a color scheme showing the status of each listing (new, old listing, etc.), flags to indicate listings with open houses scheduled, a listing showing available times for showings, and whether multiple showings are allowed for the listing.

b. Scheduling Showings

Showings may be automatically scheduled for property listings through the appointment server 100 in one embodiment of the invention. In the event that a showing agent 18 wishes to show more than one listing on a tour, scheduling may take place prior to the generation of a map (described above) for the showing agent 18, so that the showing agent 18 can have confirmed showing times prior to generation of a map and directions between showings. It should be noted that listing agents 12 and showing agents 18 may continue to communicate with sellers 10 and potential buyers 5 via telephone or other methods to keep professional relationships alive and to discuss steps to be taken to purchase property or to sell listed property.

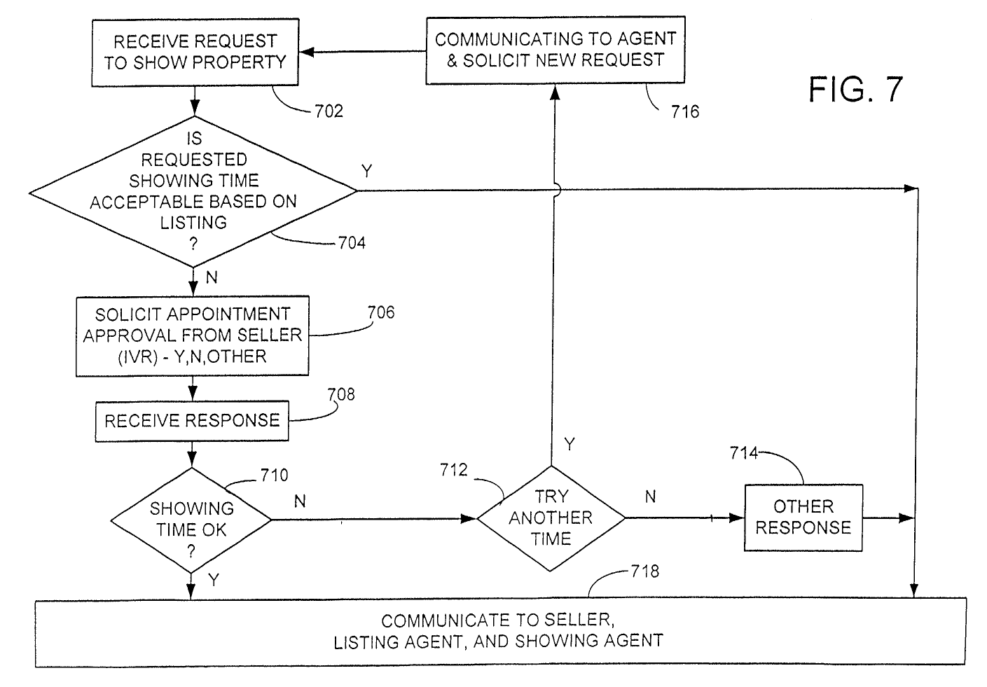

FIG. 7 is a flow chart of one embodiment of the scheduling and appointment process of one embodiment of the invention, and FIG. 3 also depicts communications used in an embodiment of the invention. A showing agent 18 may request to show a property listing at a certain time, as depicted by numeral 300 in FIG. 3. Referring again to FIG. 7, the appointment server 100 receives this request 702. In some listings, a seller 10 may indicate that certain times are acceptable for showings and that only notification is required to the seller 10. The appointment server 100, therefore, may query whether the requested showing time is acceptable based on the listing record, as depicted by numeral 704 of FIG. 7. If the showing time is acceptable, the showing agent 18 will be notified (via the Web, e-mail, or telephone or IVR), and notification may be sent to the showing agent 18, listing agent 12, listing office 14, and showing office 20. FIG. 7 depicts these acts as numeral 718, and FIG. 3 depicts these acts as numerals 302, 304, and 306. FIG. 3 also depicts communication between the listing agent 12 and the appointment server 100 for clarification or further information as numeral 303. When the showing agent 18 is notified that the showing time is acceptable, the notification (Web, e-mail, telephone, or IVR) may include any combination of the following pieces of information, which may be accessed from the appointment server 100 or a database attached thereto: the lock box combination for the home, special showing instructions, and security issues for the home. In this embodiment, the showing agent 18 may be automatically provided with all of the information that is necessary for a property showing. In one embodiment, only a showing agent 18 with a MIN can access a web page or IVR messages that include responses from sellers 10 of property to requests to show property, so the lock box combination and other confidential information may be kept secure.

In the event that the showing time is not automatically acceptable based on the listing record, the appointment server 100 may place a call, via the IVR system 104, to the seller 10 to solicit appointment approval, as depicted by numeral 706 in FIG. 7 and numeral 306 in FIG. 3. The solicitation to the seller 10 may ask for a voice or touch-tone response indicating that the time is acceptable, not acceptable, or asking for some other response. If the showing time is acceptable (numeral 710 in FIG. 7), this information may be automatically communicated to the one or more of the listing agent 12 and showing agent 18, as well as to the listing office 14 and showing office 20 (some realty boards require appointment confirmation with a showing office 20 and not just with a showing agent 18). Information, such as the lock box combination, may also be provided to the showing agent 18 as discussed above.

If the showing time is not acceptable and the showing agent 18 should try another time, as indicated by numeral 712 in FIG. 7, a message may be sent via e-mail, telephone, or the Web to the showing agent 18 to communicate the seller's response and to solicit a new request to show the property (indicated by numeral 716 in FIG. 7). If the seller 10 has some response other than yes or no or try another time (as indicated by numeral 714 of FIG. 7), such as a need to talk with the listing agent 12, this message may be automatically communicated to the listing agent 12 and/or showing agent 18. In an embodiment in which the appointment server 100 contains a list of available times for showings in the listing for a property, the list of acceptable times may be provided to the potential buyer 5 or showing agent 18 in response to a request for a showing (if the requested showing time is not acceptable). The listing agent 12 may then contact the seller 10 via traditional methods to resolve issues relating to showing the property and, in one embodiment, the listing agent 12 or the seller 10 may phone in through the IVR system 104 (or enter via the web site) a response to a request to show property. In the event that the showing agent 18 is using the Web to request showing times, the response from the seller 10 may be received through the Web in a matter of moments and, if a response from the seller 10 is not received within a threshold time period, a message may be displayed to the showing agent 18 to indicate that a response will be posted later or that the showing agent 18 will be notified via IVR, e-mail, or otherwise.

In one embodiment, information for listing agents and offices 12, 14, such as scheduled or attempted showings and requests to contact the seller 10, may be communicated via the IVR system 104 or via e-mail. In another embodiment, information for listing agents 12 or listing offices 14 may be compiled in the appointment server 100 for presentation over the Web. In such a situation, the listing agent 12 may log on to the web site at a convenient time and check the status of specific listings to determine whether showings have been scheduled or attempted and to determine if there have been requests to contact the seller 10. Market intelligence and statistical reports may also be made available to the agents in such an embodiment.

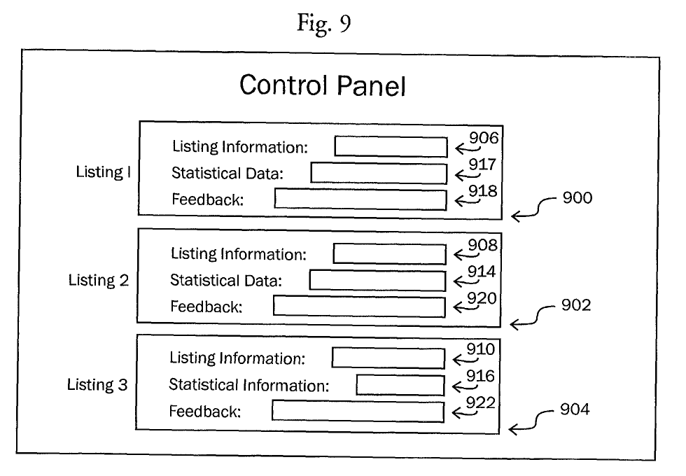

The present invention may employ a control panel for a listing agent or office. FIG. 9 shows an embodiment of a control panel screen used in the present invention. The control panel may contain a listing of all of the properties an agent has listed or may display all of the listings that a broker or listing office has for all of its agents. For example, as shown in FIG. 9, an office may have 3 listings. Of course a control panel may have more or less listings. Three listings are used for illustrative purposes only. These are designated as Listing 1 (900), Listing 2, (902) and Listing 3 (904). In one embodiment, the control panel can be presented as a Web page, and can contain not only the listing information 906, 908, 910, but also the statistical data associated with each listing 912, 914, 916 and any feedback 918, 920, 922. The control panel can be exclusive to the agent or office, by being created only to be viewed by the specific listing agent or listing agents in a specific office. This could be accomplished by requiring log on information such as a password in order to access the information.

The control panel can obtain the listing data in a number of ways. In an embodiment in which the appointment server is linked to the MLS, the server can capture all of the listings for that agent or listing office from the MLS. The control panel can also list information entered into the system from the agent or agents from that office. In one embodiment, the control panel is a Web screen that allows an agent or broker to see all of the listing information for that agent or listing office, such as length of time on the market, number of showings the property has had, number of days since the last showing, leads generated through the listing, and any feedback obtained from showing agents on the property.

The control panel can be used to notify the agent or broker of requests to show properties. For example, if a showing agent wants to show a property, a request can be submitted as described in this specification, either through the MLS or through a server as described herein. The control panel can then indicate to the broker or agent that a request has been submitted, by highlighting the specific listing, moving the listing to the top of the list, making the listing flash, changing the color of the listing on the screen, or any combination of these features. For example, in one embodiment, if a showing agent requests to show Listing 3 (904), Listing 3 will be moved ahead of Listing 1 (900) on the Web page, the color of the field or the font will change, and the listing will flash.

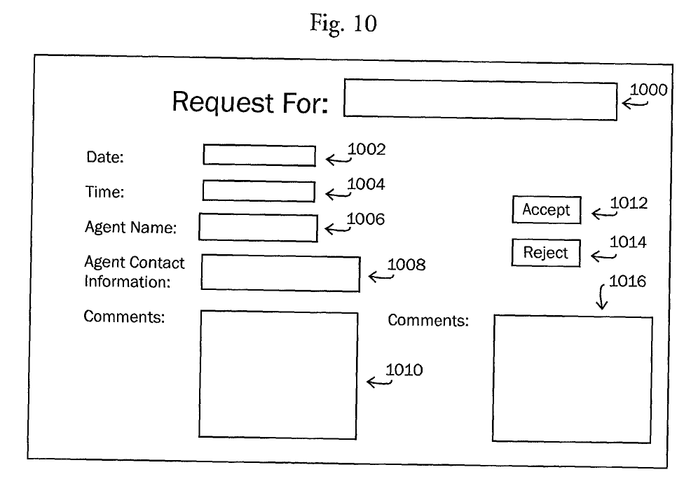

In one embodiment, the agent or broker can then click on that listing, and a separate screen appears. An example of the screen is shown in FIG. 10. The screen can show the agent or broker the details of the request, such as the address of the listing 1000, the requested date 1002, the requested time 1004, the showing agent 1006, contact information 1008, and any comments 1010. The broker or agent can then accept the request by clicking on button 1012, or reject the request by clicking on button 1014. In one embodiment, the listing agent or broker can add comments 1016, such as a suitable alternative time for a showing or comments specific to the property. The appointment server could then send an email, a fax, or an IVR telephone call to the requester, indicating the response.

A showing agent 18 may, in one embodiment of the invention, request multiple showing times for different property listings based on search results of property listings through use of either the web server 102 of the appointment server 100 or through the IVR system 104. The showing agent 18 may then log off the web site (or hang up the phone), and then check to determine the status of the requested showings by phone or through the web site at a later time. The showing agent 18 may therefore arrange for several property showings at one time, in effect setting up a “tour” of property showings. After the showing agent 18 receives the results, the showing agent 18 may request different showing times (depending on the seller's 10 response or changed circumstances) and then print a schedule and map for showings. In other embodiments, the map for the showings may be displayed and the showing agent 18 may click on listings to delete the listings or modify the showing times. For instance, if a desired showing time for one property is not available, a different showing time may be needed for a number of the properties of the tour. The appointment server 100 may assign an identification code to the tour, and, depending on the results of the requests for showings, the showing agent 18 may recall the tour and modify requested showing times or properties without having to re-enter all of the information for the desired showings a second time. The showing agent 18 may also change requested showing orders or dates. After the showing agent 18 has found an acceptable tour in terms of available showing times, maps (showing directions between showings) and any other information needed for a showing, such as lock box combinations and showing directions, may be provided to the showing agent 18 for each home as discussed above. In many situations, seller's 10 are communicated with by the appointment server 100 quickly and a response from the seller 10 to the requested showing is received by the showing agent 18 in a matter of minutes or even seconds.

The appointment server 100 may, in one embodiment, notify the listing agent 12 or listing office 14 by e-mail or IVR when the seller 10 does not agree to a requested showing time or if the seller 10 has some response other than yes or no to a requested showing time. The listing agent 12 may then speak with the seller 10, as indicated by numeral 314 in FIG. 3, to discuss and resolve issues related to showing the property.

4. Gathering Feedback After Property Showings

After a property has been shown by a showing agent 18, the appointment server 100 may automatically request feedback from the showing agent 18, as indicated by numeral 320 in FIG. 3. To automatically request this feedback, the appointment server 100 may simply request the feedback the day of the showing or the day after a showing was scheduled. The feedback may be requested by IVR, web page forms, or by e-mail. After the feedback has been received by the appointment server 100 from the showing agent 18, the feedback may be automatically communicated by e-mail or otherwise to the listing agent 12 (numeral 322 of FIG. 3). In another embodiment, the feedback request may be directed to the showing agent 18 but then sent via e-mail directly to the listing agent 12. The listing agent 12 may then communicate feedback and other information to the seller 10 of the property via traditional methods to ensure that a personal and professional relationship is maintained. FIG. 3 also depicts a thank you message 321 that may be sent from the listing agent 12 to the showing agent 18 after feedback has been received by the listing agent 12.

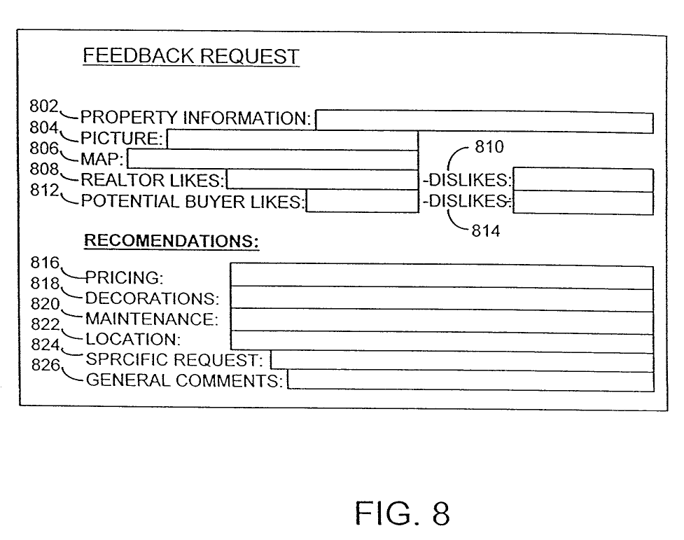

One suitable feedback request that may be sent via e-mail to a showing agent 18 is shown in FIG. 8. FIG. 8 illustrates one possible form of a feedback request, and such a request could also be solicited using an IVR system or through a web page. FIG. 8 indicates that the feedback request may contain property information 802 (such as an address, the style of the home, and the price, among other types of information) so that the showing agent 18 will recognize the property, as well as a picture 804 of the property and a map 806 showing the location of the property. The feedback request may solicit information on the realtor's likes 808 and dislikes 810, as well as the potential buyer's 5 likes 812 and dislikes 814. As with the other web pages or e-mails described in this specification, any variety of data solicitation and entry methods and systems known to those skilled in the art, such as data entry boxes, drop down boxes, and the like, may be used for the feedback request. The feedback request may also include a section for recommendations, including recommendations on pricing 816, decorations 818 of the property, maintenance 820, and location 822, and whether the location of the property was properly indicated on maps generated by the appointment server 100. The feedback request form may also contain a section for specific requests 824 that the listing agent 12 or seller 10 desires to be solicited, and a section for general comments 826.

5. Mining Information for Property

Listing agents 12 (or possibly a showing agent 18, the seller 10, or a potential buyer 5) may check on the status of listed properties or view historical information through the appointment server 100. FIG. 3 depicts the availability of such statistical reports and information as numeral 350. Statistical information may be kept regarding how often a particular listing has been retrieved as relevant to a showing agent's 18 search, how many requests to show the listing have occurred, how many actual showings have occurred, how many showings have been canceled, and other information that may be relevant to the ability of the property to be sold. Because prior art methods and systems have no direct route of tracking this information, the system and method of the invention may aid sellers 10 and listing agents 12 in selling property. Such information may be available through web pages within the appointment server 100, such that some web pages contain specific types of information for a property listing and other web pages contain information about the market as a whole, for instance, the number of homes sold or shown in a particular price range.

The web site of the appointment server 100 may provide a center for information for sellers 10 and showing agents 12 that contains feedback information from showings, statistical information as described above for particular listings, and market activity. Such information may be viewed in yearly, monthly, weekly, or daily periods. Numerous types of information may be made available, including market activity trends pertaining to a particular style or price of property, showing activity for a listed property compared with activity for other similar listings, geographic distribution information for listings, and showing and sales information for particular realtor offices and for the market as a whole. In addition, other information may be provided, such as market activity with respect to the calendar time of the year.

Other possible data mining features include online search capabilities for open houses that meet certain selection criteria, along with mapping information, as described above, for those open houses. Potential buyers 5 may be profiled and certain listed properties may be suggested as falling within categories (i.e., price, location, number of bedrooms) that such a profiled buyer 5 may be interested in. Another possible feature is the profiling of property along with the actual buyers 5 of the property in an effort to determine if certain classes of products and/or services are likely to sell to those purchasers. Information regarding buyers 5 may then be provided to vendors of products and/or services so that sales efforts may be made to the buyer 5.

The appointment server 100 may have automated accounting and billing systems, denoted as numeral 112 and 112a in FIG. 4, to automate the collection of billing information for the appointment server 100. The proprietor of the appointment server 100 may charge realtors (listing agents 12, listing offices 14, showing agents 18, and showing offices 20) based on usage of the appointment server 100. The appointment server 100 may, in one embodiment, charge showing agents and offices 18, 20 based on searches for property, scheduled showings, calls made to and from the IVR system 104, and based on usage of other features of the invention. In addition, listing agents and offices 12, 14 may be charged based on showings of listed property, listings of property with the appointment server 100, feedback submissions, or other usages of the appointment server 100. In other embodiments, showing agents and offices 18, 20 and listing agents and offices 12, 14 may be charged periodic fees, such as monthly fees, to use the appointment server 100. The accounting and billing systems 112, 112a of the appointment server 100 may track such billing information to automate accounting and billing procedures.

### C. SUMMARY

The method and system of the invention provide numerous advantages over the prior art. The method and system benefit showing agents 18 and realtors by providing for timely and automated appointment scheduling. Showing agents 18 also benefit from the searching capabilities and mapping features of the invention that allow showing agents 18 to quickly and easily search for information on property listings, determine where the listings are located, schedule appointments for showing properties, and generate maps and further information about the listings.

Listing agents 12 and realtors benefit from the system and method of the invention in that the appointment scheduling is automated so that human interaction from the listing agent 12 or listing office 14 may not be necessary to schedule showings of property. This decreased human intervention is not only convenient for the listing agent 12 and listing office 14, but it saves in labor costs that prior art methods and systems require. Listing agents 12 may be able to sell property faster through the method and system of the invention, and labor-intensive desk activities may be removed. Both listing agents 12 and showing agents 18 benefit from the automated feedback requesting and reporting features of the invention. A feedback request may be automatically sent to the showing agent 18 from the appointment server 100 so that the showing agent 18 only has to take a few minutes to fill out and submit the feedback form at a convenient time. In addition, specific requests for feedback may be included in feedback requests, and, in one embodiment, responses to certain queries in feedback requests may be required for submission of a response to the feedback request. The automated feedback feature of the invention, therefore, not only simplifies the feedback process, but it allows for the collection of more detailed and more specific information from property showings that may allow a seller 10 or a listing agent 12 to adjust pricing, property features, or property presentation in order to complete a sale of the property. The feedback features of an embodiment of the invention may also provide industry uniformity and standards for the feedback process. In one embodiment, certain standard queries may be used for all property listings and specific queries may be used for particular listed properties.

Sellers 10 of property, as well as potential buyers 5, may also benefit from the features of the invention. Potential buyers 5 may be able to locate property listings easier than in prior art methods and systems, and mapping features aid in showings of properties. Sellers 10 may be aided by simplified appointment scheduling, information mining on scheduled and actual showings, and by the automated feedback mechanism of the invention.

The accompanying Figures described above depict embodiments of the present invention, and features and components thereof. With regard to references in this specification to computers, the computers may be any standard computer including standard attachments and components thereof (e.g., a disk drive, hard drive, CD player or network server that communicates with a CPU and main memory, a sound board, a keyboard and mouse, and a monitor). The processor of the CPU in the computer may be any conventional general purpose single- or multi-chip microprocessor such as a Pentium® processor, a Pentium® Pro processor, a 8051 processor, a MIPS® processor, a Motorola Processor, a Power PC® processor, or an ALPHA® processor. In addition, the processor may be any conventional special purpose processor such as a digital signal processor or a graphics processor. The microprocessor has conventional address lines, conventional data lines, and one or more conventional control lines. With regard to references to software, the software may be standard software used by those skilled in the art or may be coded in any standard programming language to accomplish the tasks detailed below.

The system and method of the invention may use the “World Wide Web” (“Web” or “WWW”), which is that collection of servers on the Internet that utilize the Hypertext Transfer Protocol (“HTTP”). HTTP is a known application protocol that provides users access to resources, which may be information in different formats such as text, graphics, images, sound, video, Hypertext Markup Language (“HTML”), as well as programs. Upon specification of a link by the user, the client computer makes a TCP/IP request to a Web server and receives information, which may be another “Web page” that is formatted according to HTML. Users can also access other pages on the same or other servers by following instructions on the screen, entering certain data, or clicking on selected icons.

Servers run on a variety of platforms, including UNIX machines, although other platforms, such as Windows 95, Windows NT, and Macintosh may also be used. Computer users can view information available on servers or networks on the Web through the use of browsing software, such as Netscape Navigator, Microsoft Internet Explorer, Mosaic, or Lynx browsers. A typical Web page is an HTML document with text, “links” that a user may activate (e.g. “click on”), as well as embedded URL's pointing to resources, such as images, video or sound, that the client may activate to fully use the Web page in a browser. Furthermore, HTTP allows for the transmission of certain information from the client computer to a server. The server can then post this information on its web site, forward it on to another user or server, or save it to a database for later use.

While the present invention has been described with reference to several embodiments thereof, those skilled in the art will recognize various changes that may be made without departing from the spirit and scope of the claimed invention. Accordingly, this invention is not limited to what is shown in the drawings and described in the specification but only as indicated in the appended claims, nor is the claimed invention limited in applicability to one type of computer or computer network. Any numbering or ordering of elements in the following claims is merely for convenience and is not intended to suggest that the ordering of the elements of the claims has any particular significance other than that otherwise expressed by the language of the claims.

What is claimed is:

1. A method for scheduling real estate appointments, the method comprising:
(a) compiling listing information for a plurality of listings;
(b) displaying the listing information on a control panel;
(c) receiving from a showing realtor a request to show at least one of the plurality of listings; and
(d) displaying the request on the control panel.

2. The method of claim 1, wherein the at least one requested listing is differentiated from other listings on the control panel.

3. The method of claim 2, wherein the at least one requested listing is differentiated by one of the following: highlighting the requested listing, moving the requested listing to the top of the list, changing the background color of the requested listing, changing the font color of the requested listing, and flashing the requested listing.

4. The method of claim 1, further comprising viewing one of the following regarding the request to show at least one of the plurality of listings: showing realtor name, showing realtor contact information, requested showing date, requested showing time, and comments regarding the showing request.

5. The method of claim 1, further comprising accepting the request via the control panel.

6. The method of claim 5, further comprising automatically sending the showing realtor notification of the acceptance.

7. The method of claim 6, wherein the notification is sent by one of the following: email, fax, and IVR.

8. The method of claim 1, wherein the control panel is a graphical user interface.

9. The method of claim 1, further comprising electronically sending the showing realtor a comment regarding an alternative showing time.

10. The method of claim 9, further comprising the showing realtor accepting the alternative showing time.

11. The method of claim 1, wherein the listing information comprises the address of each of the plurality of the listings and one of the following: number of days on the market, feedback from showing agents, number of days since last showing, number of showings, price information, and a map of the listing.

12. An apparatus for scheduling real estate appointments, the apparatus comprising: an appointment server containing instructions for:
(i) compiling listing information from at least one database for properties listed by one of a listing agent and a listing office;
(ii) displaying the compiled listing information on a control panel;
(iii) receiving a request from a showing agent to show a listing selected from the displayed listings; and
(iv) automatically displaying the request on the control panel.

13. The apparatus of claim 12, wherein the appointment server further contains instructions for electronically receiving a response regarding request approval and electronically communicating the response to the showing agent.

14. The apparatus of claim 12, wherein communications take place over one of: IVR, email, and fax.

15. The apparatus of claim 12, wherein the appointment server further contains instructions for storing listing information inputted by the one of the listing agent and the listing office.

16. The apparatus of claim 12, wherein the appointment server further contains instructions for communicating with a remote database.

17. The apparatus of claim 12, wherein the requested is indicated by one of the following:
highlighting the requested listing, moving the requested listing to the top of the list, changing the background color of the requested listing, changing the font color of the requested listing, and flashing the requested listing.

18. The apparatus of claim 12, wherein the listing information comprises the address of each of the displayed listings and one of the following: number of days on the market, feedback from other showings, number of days since last showing, number of showings, price information, and a map of the listing.

19. The apparatus of claim 12, wherein the appointment server further contains 15 instructions for allowing the listing agent or listing office to view detailed information regarding the request.

20. A method for electronically allowing a showing agent to schedule a real estate showing of at least one listed property requested from a plurality of listed properties offered by a listing agent or a listing office, the method comprising:
i) electronically compiling listing information for the plurality of listed properties;
ii) presenting the compiled listing information for the plurality of listed properties on a display;
iii) receiving a request to show the requested listed property from the showing agent;
iv) automatically changing the requested listed property on the display in a manner that visually alerts the listing agent or listing office that the request has been submitted;
v) viewing detailed information regarding the request from the showing agent; and
vi) responding to the request from the showing agent.
